(19) United States
(12) Patent Application Publication
(10) Pub. No.: US 2008/0033737 A1
(43) Pub. Date: Feb. 7, 2008

(54) Method and a system for providing a business organization with an online questionnaire to automatically create a manual for repsonding to a crisis

(75) Inventor: Hilik Goldstein, Tel Aviv (IL)

Correspondence Address: TIAJOLOFF & KELLY, CHRYSLER BUILDING, 37TH FLOOR, 405 LEXINGTON AVENUE, NEW YORK, NY, 10174, US

(73) Assignee: CrisAid Sarl, Geneva (CH)

(21) Appl. No.: 11/498,117

(22) Filed: Aug. 2, 2006

(51) Int. Cl. G06Q 10/00; G06Q 30/00; G06F 17/50

(52) U.S. Cl. 705/1; 705/7

(57) ABSTRACT

A method for online preparation of a business organization crisis manual responsive to information entered by a representative of the business organization logged on to a Website operative to automatically provide the preparation. The method includes entering information identifying the type of business. The method also includes entering information to provide details of the organization of the business, entering information to provide the nature of any indictment history of the business organization, answering bimodal questions identifying any relevant risk factors to the business organization and preparing the crisis manual and making the crisis manual available, such that the manual is automatically prepared by software resident on the Website.

### FIELD OF THE INVENTION

The present invention relates generally to methods and systems for implementing a crisis response, and more particularly to a method and system for providing a business organization with an online questionnaire to automatically create a manual for responding to a crisis.

### BACKGROUND OF THE INVENTION

Software for automated questionnaires to create a manual for helping business to respond to crisis situations is known in the art.

For example, in published PCT application WO 00/02137, Schlick et al disclose a computer software application, graphical user interface and method for entering information concerning a complex business situation, refining such information in a stepwise manner through the interface, generating a list of effective actions for addressing such a business situation, and storing such information in a knowledge base adapted for future query and reporting use of such a complex business situations. A set of screen sequences allows entry of specific aspects of such a situation to generate an action list. A situation appraisal sequence allows entry of concerns stemming from the situation to prioritize such concerns. A problem analysis sequence allows entry of causes of a problem, and refining the causes to determine a true cause. A decision analysis sequence allows entry of alternatives concerning a decision, and refines such alternatives to determine one which suits the objective.

Other patents provide online help for public school students having crises. E.g., US Pat. No. 6,754,674 to Meyers, et al, discloses a method and apparatus for creation and maintenance of incident crisis response plans. In recent years, a number of high profile acts of violence and other crises have occurred in public school and other institutional settings, gaining the attention of media and large segments of the public. For this and other reasons, a large and growing number of municipalities have required that public school administrators create detailed crisis response plans and make them available in each school and district office for use during a crisis. Crisis response plans are written procedures with explicit intent to protect and sustain life, reduce emotional trauma, assist in emotional recovery from trauma, and minimize personal injury and/or damage to the school facilities in the event of a crisis incident. A client station receives input data from a user relating to a particular crisis incident.

Therefore, it would be advantageous to provide a method and system for enabling a business organization fill out an online questionnaire which then automatically generates a manual for responding to a crisis.

### SUMMARY OF THE PRESENT INVENTION

Accordingly, it is a principle object of the present invention to provide a method and system for enabling a business organization fill out an online questionnaire which then automatically generates a manual for responding to a crisis.

It is another principle object of the present invention to provide a method and system for automatically generating a manual for responding to a variety of crisis situations.

It is a further principle object of the present invention to provide a method and system for automatically implementing an algorithm for generating a manual for responding to crisis situations.

A method is disclosed for online preparation of a business organization crisis manual responsive to information entered by a representative of the business organization logged on to a Website operative to automatically provide the preparation. The method includes entering information identifying the type of business. The method also includes entering information to provide details of the organization of the business, entering information to provide the nature of any indictment history of the business organization, answering bimodal questions identifying any relevant risk factors to the business organization and preparing the crisis manual and making the crisis manual available, such that the manual is automatically prepared by software resident on the Website.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in which:

FIG. 1a is a screenshot illustration of the customer logon procedure, constructed in accordance with the principles of the present invention;

FIG. 1b is a screenshot illustration of the customer choices of available actions, constructed in accordance with the principles of the present invention;

FIG. 2 is a screenshot illustration of the dialog box for entry of the customer company name, constructed in accordance with the principles of the present invention;

FIG. 3 is a screenshot illustration of the table for entry of the customer crisis management team personal information, constructed in accordance with the principles of the present invention;

FIG. 4 is a screenshot illustration a listing for selecting the customer industry type, constructed in accordance with the principles of the present invention;

FIG. 5 is a screenshot illustration of the of the dialog box for entry of customer decision maker's personal information procedure, constructed in accordance with the principles of the present invention;

FIG. 6 is a screenshot illustration of a first set of risk factor bimodal questions, constructed in accordance with the principles of the present invention;

FIG. 7 is a screenshot illustration of a second set of risk factor bimodal questions, constructed in accordance with the principles of the present invention;

FIG. 8 is a screenshot illustration of a third set of risk factor bimodal questions, constructed in accordance with the principles of the present invention;

FIG. 9 is a screenshot illustration of a fourth set of risk factor bimodal questions, constructed in accordance with the principles of the present invention;

FIG. 10 is a screenshot illustration of a fifth set of risk factor bimodal questions, constructed in accordance with the principles of the present invention;

FIG. 11 is a screenshot illustration of a general risk factor question, constructed in accordance with the principles of the present invention;

FIG. 12 is a screenshot illustration relating to the personalized crisis management manual, constructed in accordance with the principles of the present invention;

FIG. 13 is a screenshot illustration of the crisis control dashboard, constructed in accordance with the principles of the present invention;

FIG. 14 is a screenshot illustration of the crisis control activities for a particular location (station4), constructed in accordance with the principles of the present invention;

FIG. 15 is a screenshot illustration of the customer crisis control checklist for a particular location, constructed in accordance with the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

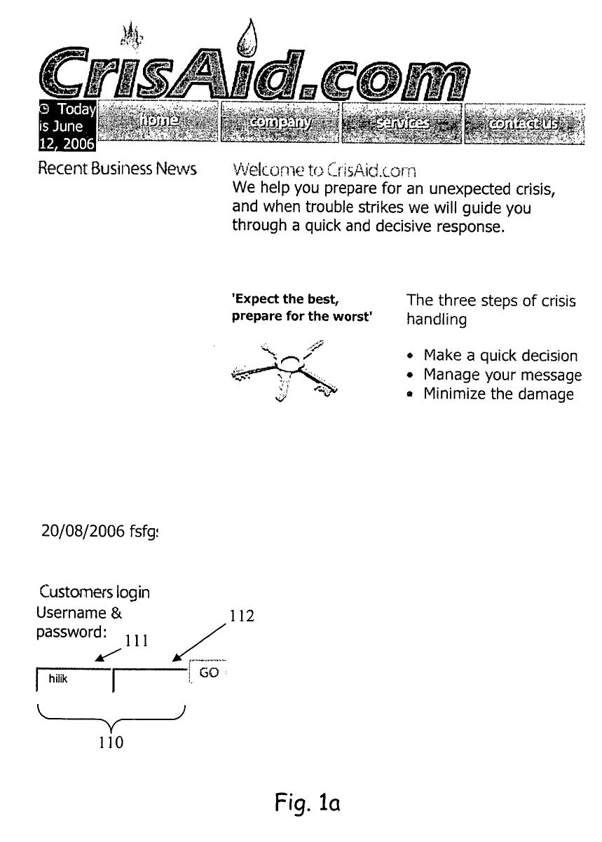

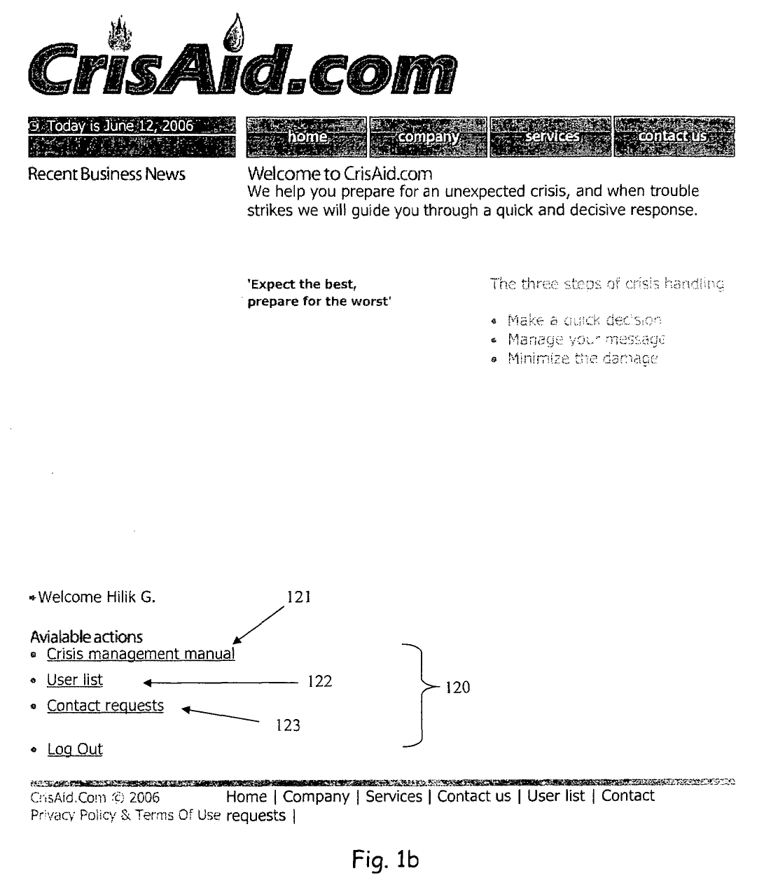

FIG. 1a is a screenshot illustration of the customer logon procedure, constructed in accordance with the principles of the present invention. The dialog box 110 has a place for the username 111 and the password 112.

FIG. 1b is a screenshot illustration of the customer choices of available actions, constructed in accordance with the principles of the present invention. A list of available actions 120 is shown. The main choice is for entry to the series of screens for preparing the crisis management manual 121. Also available is a variety of user list options 122 and a list of contact requests 123, for example, how to contact in various resources in times of emergency.

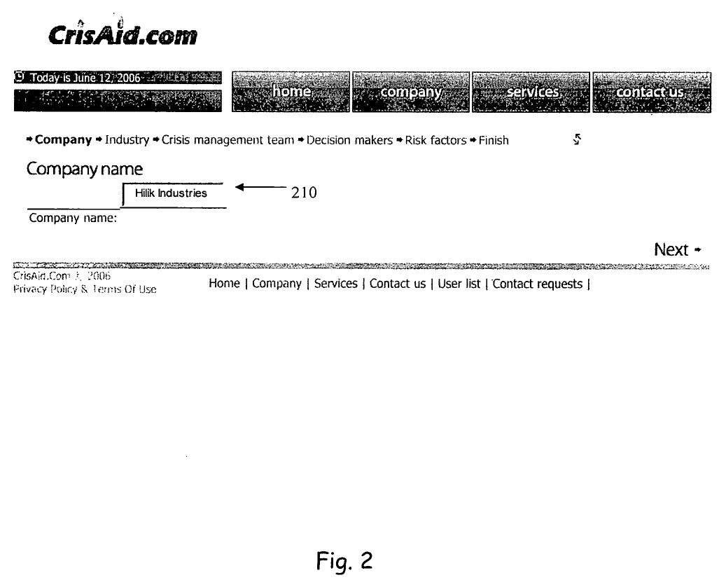

FIG. 2 is a screenshot illustration of the dialog box for entry of the customer company name, constructed in accordance with the principles of the present invention. A dialog box is provided for entry of the company name 210.

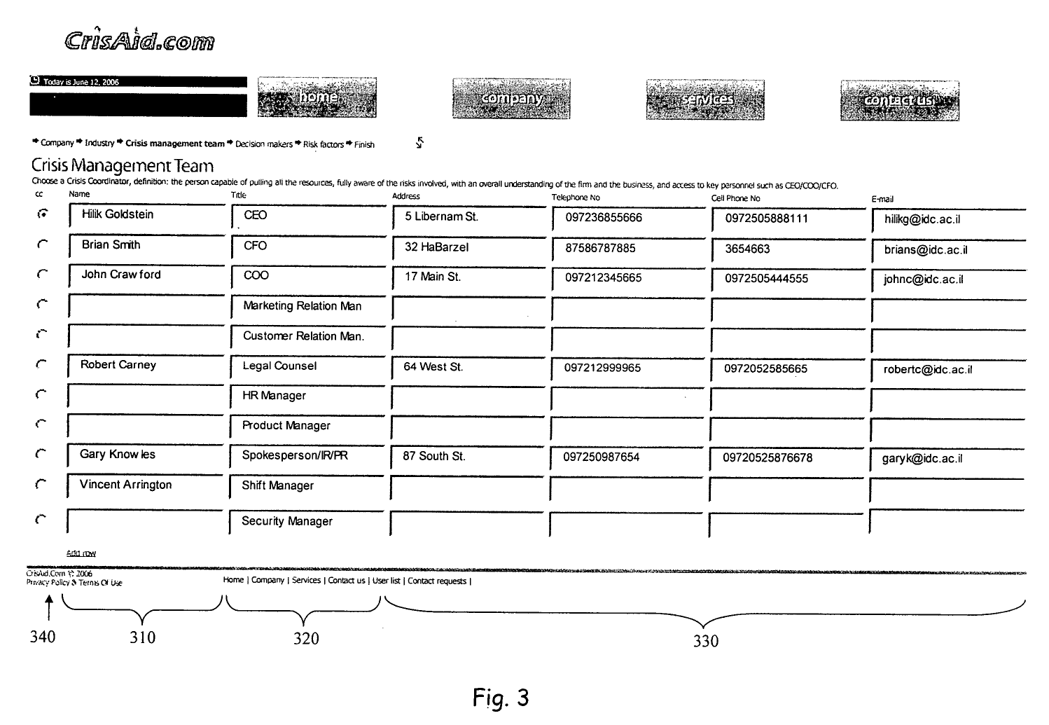

FIG. 3 is a screenshot illustration of the table for entry of the customer crisis management team personal information, constructed in accordance with the principles of the present invention. The listed information includes name 310, title 320 and contact information 330. A crisis coordinator (cc) 340 should also be designated.

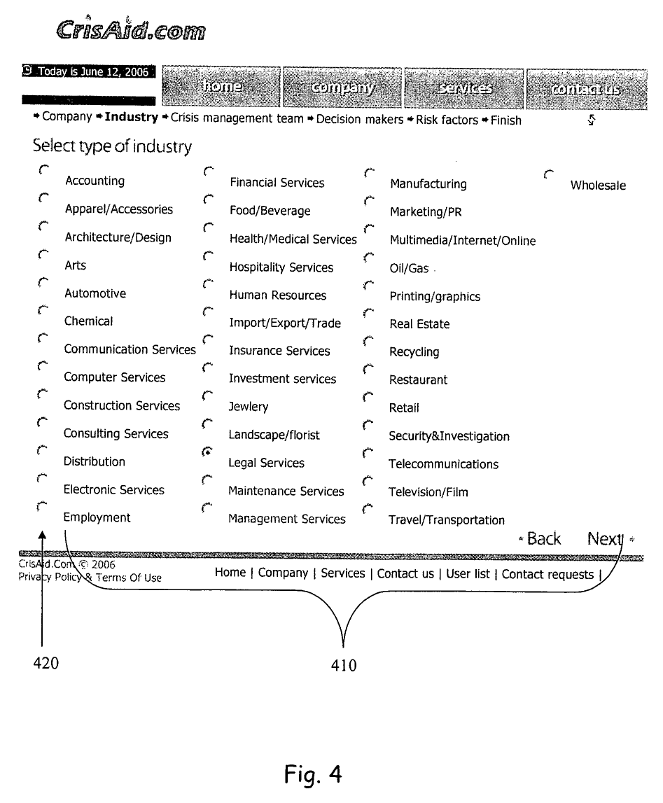

FIG. 4 is a screenshot illustration a listing for selecting the customer industry type, constructed in accordance with the principles of the present invention. A wide of variety of choices for industry type 410 is shown, with a bimodal switch for each 420.

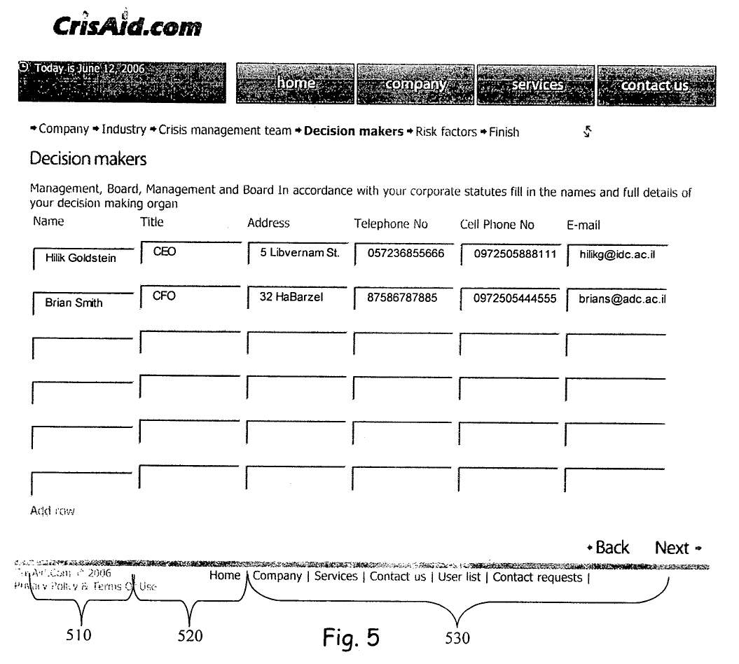

FIG. 5 is a screenshot illustration of the of the dialog box for entry of customer decision maker's personal information, constructed in accordance with the principles of the present invention. The listed information includes name 510, title 520 and contact information 530.

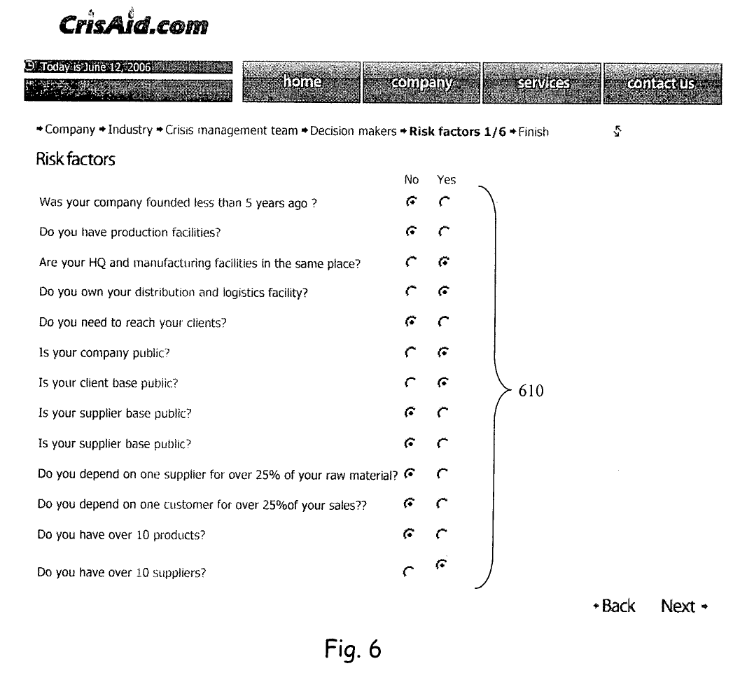

FIG. 6 is a screenshot illustration of a first set of risk factor bimodal questions, constructed in accordance with the principles of the present invention. A list of general questions related to risk 610 are presented.

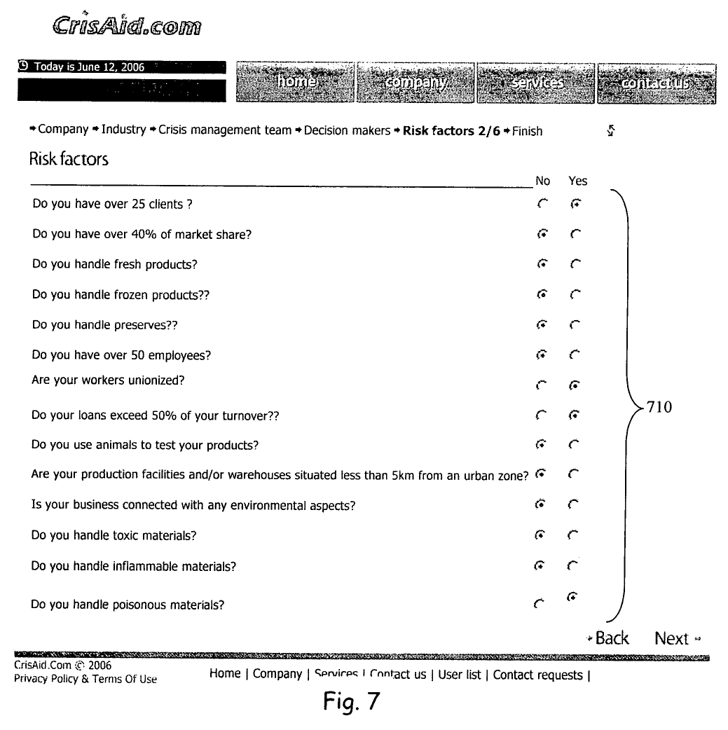

FIG. 7 is a screenshot illustration of a second set of risk factor bimodal questions, constructed in accordance with the principles of the present invention. A list of more specific questions related to risk 710 is presented.

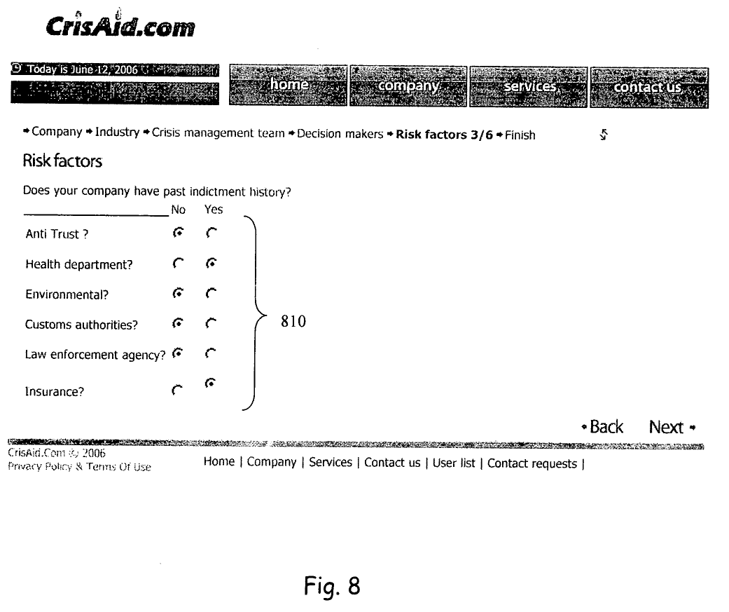

FIG. 8 is a screenshot illustration of a third set of risk factor bimodal questions, constructed in accordance with the principles of the present invention. A list of questions related to any indictment history 810 is presented.

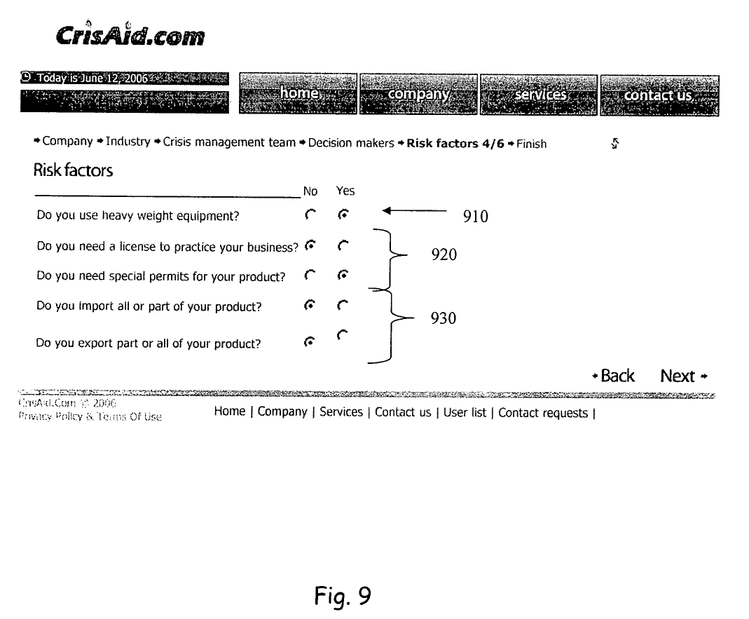

FIG. 9 is a screenshot illustration of a fourth set of risk factor bimodal questions, constructed in accordance with the principles of the present invention. Factors listed include heavy equipment 910, licenses and permits 920 and import/export 930.

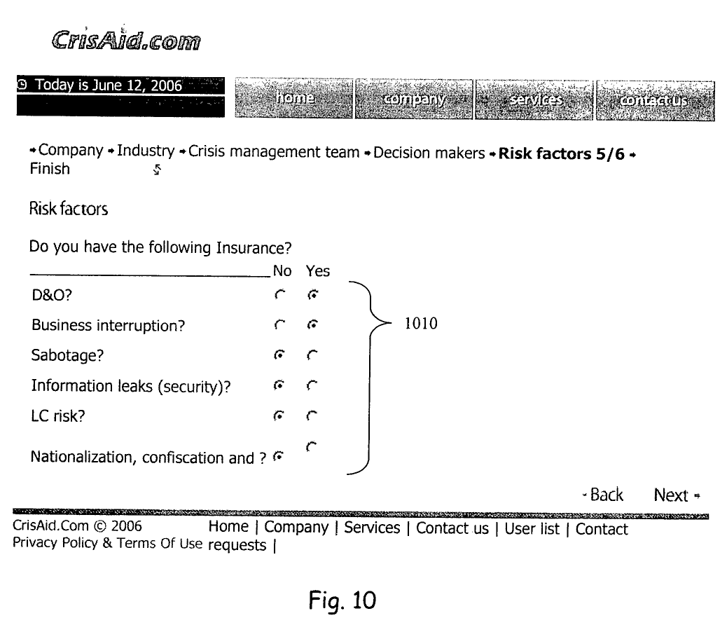

FIG. 10 is a screenshot illustration of a fifth set of risk factor bimodal questions, constructed in accordance with the principles of the present invention. A list of risk factor questions related to insurance 1010 is presented.

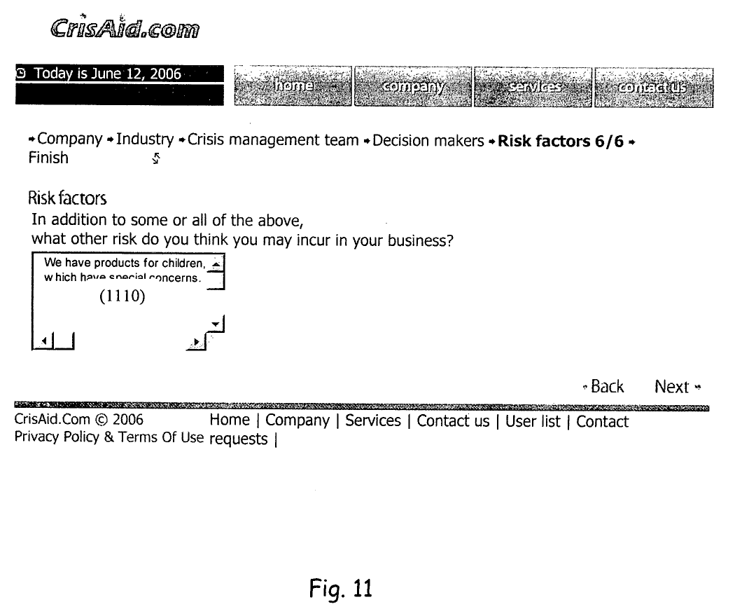

FIG. 11 is a screenshot illustration of a general risk factor question, constructed in accordance with the principles of the present invention. A dialog box relating to any other possible risk factors is shown 1110.

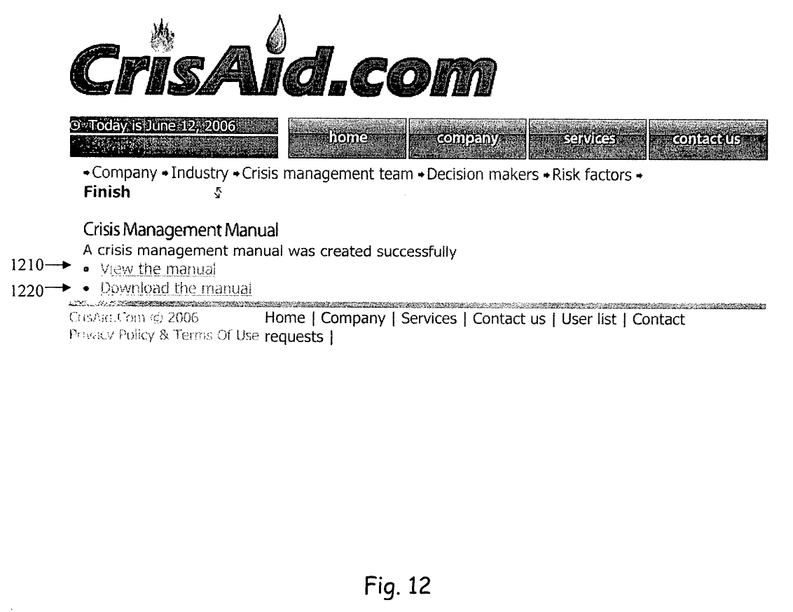

FIG. 12 is a screenshot illustration relating to the personalized crisis management manual, constructed in accordance with the principles of the present invention. Options concerning the personalized crisis management manual include viewing the manual 1210 and downloading the manual 1220.

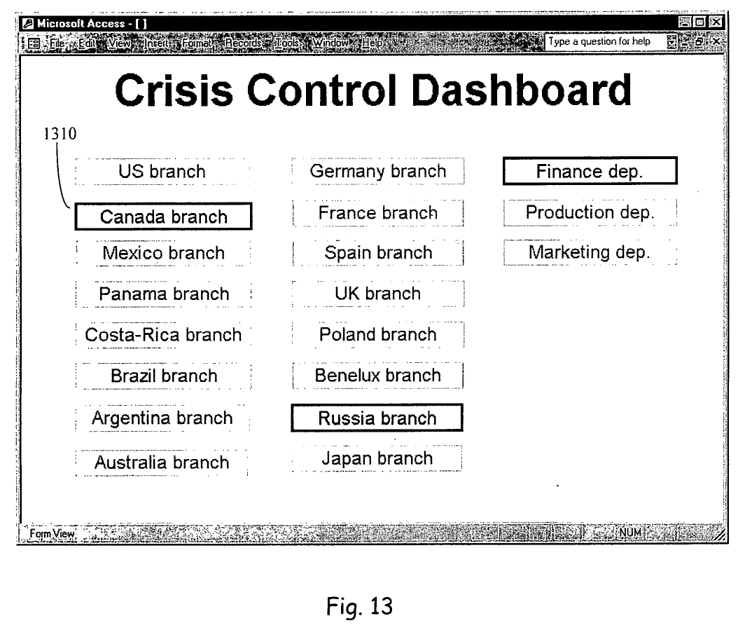

FIG. 13 is a screenshot illustration of the crisis control dashboard, constructed in accordance with the principles of the present invention. This is a tool for crisis management when a crisis occurs. The local crisis coordinator, for example will access this screen and click on his location 1310 (station 4). A crisis control activities screen will open up.

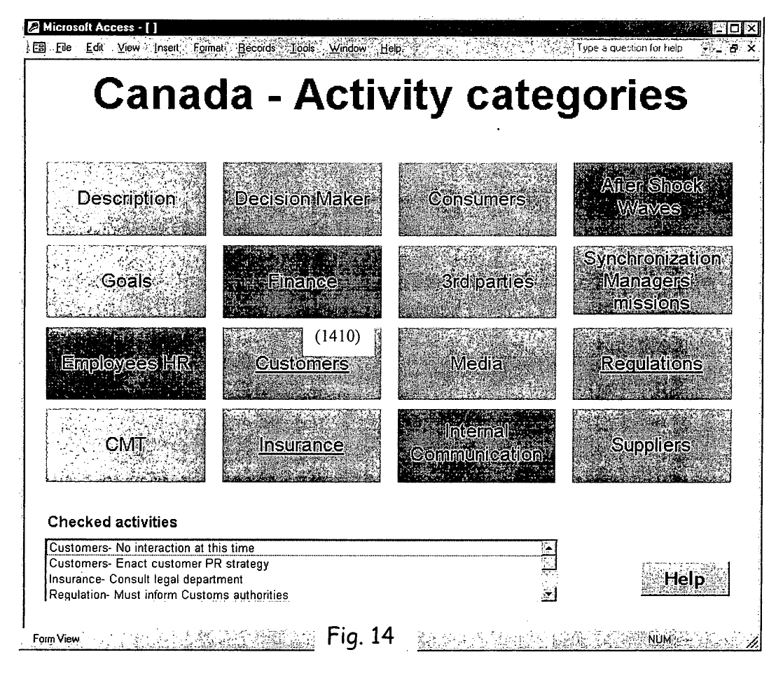

FIG. 14 is a screenshot illustration of the crisis control activities for a particular location (station4), constructed in accordance with the principles of the present invention. The crisis coordinator will then click on an activity, for example customers 1410.

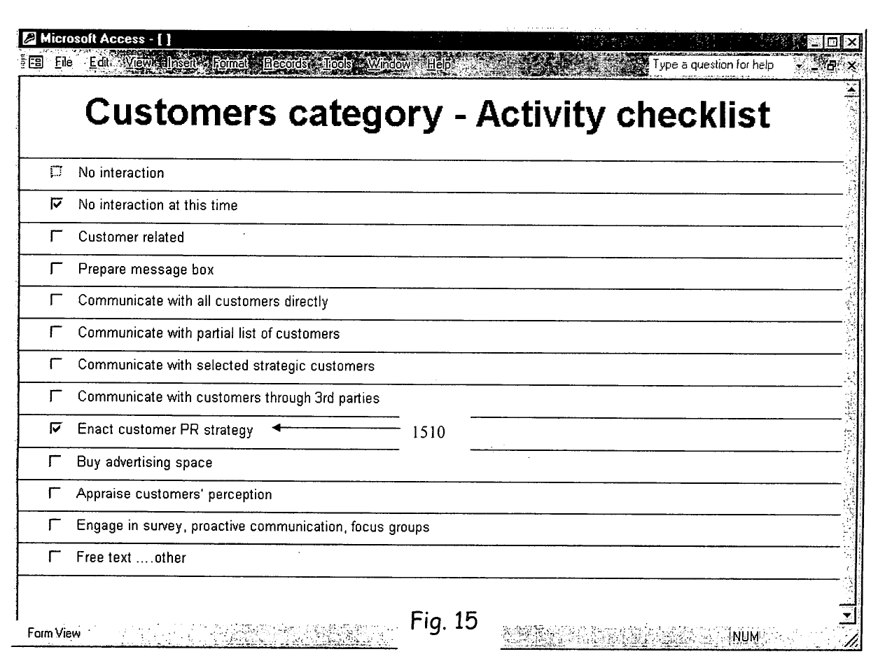

FIG. 15 is a screenshot illustration of the customer crisis control checklist for a particular location, constructed in accordance with the principles of the present invention. The crisis coordinator will then check an activity, for example “enact customer PR strategy” 1510. Alternatively, the crisis coordinator may uncheck an activity that appears on the screen as checked.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method for online preparation of a business organization crisis manual responsive to information entered by a representative of the business organization logged on to a Website operative to automatically provide said preparation, said method comprising:
entering information identifying the type of business;
entering information to provide details of the organization of the business;
entering information to provide the nature of any indictment history of the business organization;
answering bimodal questions identifying any relevant risk factors to the business organization; and
preparing said crisis manual and making said crisis manual available, such that said manual is automatically prepared by software resident on said Website.

2. The method of claim 1, further comprising entering of information to provide identification and contact details of at least one member of a crisis management team of said business organization.

3. The method of claim 1, further comprising entering of information to provide identification and contact details of at least one decision maker of said business organization.

4. The method of claim 1, further comprising entering the crisis control dashboard application.

5. The method of claim 1, wherein said making available is operative to make said crisis manual available for online viewing.

6. The method of claim 1, wherein said making available is operative to make said crisis manual available for downloading.

7. The method of claim 1, wherein said Website is operative to prepare a crisis manual for a variety of types of businesses.

8. The method of claim 1, wherein said Website is operative to prepare a crisis manual for a particular business segment.
